(19) United States
(12) Patent Application Publication
(10) Pub. No.: US 2008/0168301 A1
(43) Pub. Date: Jul. 10, 2008

(54) Method of automatically adjusting storage sources for server a system

(75) Inventor: Chih-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/651,511

(22) Filed: Jan. 10, 2007

(51) Int. Cl. G06F 11/07

(52) U.S. Cl. 714/4; 707/E17.01

(57) ABSTRACT

A method of automatically adjusting storage resources for a server system is disclosed, and the server system includes a plurality of allocators each corresponding to a plurality of network servers. If one of the network servers corresponding to one of the allocators is overloaded, the corresponding allocator will become a request allocator and the other of the allocators will become standby allocators, and then the request allocator will send an inquiry signal to the standby allocators. If the request allocator receives an acknowledgement signal from one of the standby allocators, the corresponding standby allocator will be assigned as an assigned allocator, and then a data request signal will be sent to the assigned allocator from the request allocator. If the request allocator receives server data from the assigned allocator, the network server corresponding to the server data is set as an additional network server corresponding to the request allocator so as to achieve the effect of automatically adjusting storage resources of the server system.

### FIELD OF THE INVENTION

The present invention relates to a method of automatically adjusting storage resources, and more particularly to a method of automatically adjusting storage resources for a server system.

### BACKGROUND OF THE INVENTION

Presently, we are entering an electronic information era with the advances of information industries, while various wireless communication devices, electronic products, and network transmission technologies rapidly developed with ever increasing transmission speeds. Furthermore, due to convenience and availability of the internet and various portable electronic products, unavailable wireless communications and network services in the past are realizable and gradually become essential tools for daily life. Especially, many enterprises can actively develop E-business based on the convenience provided by networks and related electronic devices, so that the enterprises can competitively attract the attention of consumers. Therefore, how to provide finer network services with higher transmission stability is one of important factors to determine the service quality of related enterprises or internet service providers, of which consumers primarily take care.

In general, the so-called server is a high-performance computer mainly functioning as a node on the internet for storing or processing information. Generally, a traditional server at least includes a processor, a hard disk, a memory unit, and a plurality of system buses, all of which are used for internet applications, so that the server will provide higher processing ability, stability, reliability, safety, extensibility, and controllability. Especially, following increasing advances of information technologies and needs the need for information flows, most companies and organizations usually use servers to provide services of related information, download, and email, so providing higher stability, processing ability, and flexibility will be a main design trend of servers and related peripherals.

To prevent the servers from generating any malfunction caused by various possible reasons for reducing the interruption probability of information access or network service, related manufacturers develop a server system having a plurality of hosts to increase the operation stability. When one of the hosts malfunctions, the other hosts can be used to support each other for providing the normal function, so as to prevent from generating the malfunction due to the shutdown of a single host in the traditional server. Meanwhile, the server system only causes a transient delay of several seconds at the user end while receiving a response from the server system, so as to considerably shorten the interruption time of the server system while preventing from damaging or losing information accessed or transmitted by the server system and the user end. However, although the traditional server system having multiple hosts has the above-mentioned advantages, there is still the problem of unbalanced loading, i.e. most transmission flow is concentrated in a few hosts, resulting in that the server system slowing down or malfunction and then the service request of the user end cannot quickly respond.

To solve the foregoing problems, related manufacturers further developed a load balance technology to minimize the occurrence of the unbalanced load, wherein a server system is generally provided with a domain name server (i.e. DNS) for allocating suitable data flow to a plurality of downstream servers in a round-robin manner, i.e. respectively transmitting data flow to each server in turn. However, said transmission manner as described above has disadvantages that the DNS cannot detect if the downstream servers overload or can not provide any service. As a result, even though some of the servers are overloaded or paralyzed, the DNS still transmits data to the overloaded or paralyzed servers, so that the static round-robin technology can not be used to process the dynamic data flow variation of the network. In other words, a server system should provide a function of dynamically adjusting the load of a domain name server (i.e. DNS) to reduce the load of downstream servers, so as to satisfy the needs of internet service providers and internet users.

It is therefore tried by the inventor to develop a method of automatically adjusting storage resources for a server system to solve the problems existing in the conventional server system that can not process the dynamic data flow variation of the network resulting in overloading of the downstream servers, as described above.

### SUMMARY OF THE INVENTION

A primary object of the present invention is to provide a method of automatically adjusting storage resources for a server system, which is applied to the server system provided with a plurality of allocators, each of the allocators correspond to a plurality of network servers, if a network server corresponding to one of the allocators is overloaded, the corresponding allocator will become a request allocator and the other becomes standby, wherein the request allocator will send an inquiry signal to the standby allocators, if the request allocator receives an acknowledgement signal from one of the standby allocators, the corresponding standby allocator will be assigned as an assigned allocator and a data request signal will be sent to the assigned allocator from the request allocator, and if the request allocator receives server data from the assigned allocator, the network server corresponding to the server data is set as an additional network server corresponding to the request allocator so as to achieve the effect of automatically adjusting storage resources of the server system, and provide a function of dynamically adjusting the data flow variation of the network to prevent overloading the allocators.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a server system according to a preferred embodiment of the present invention;

FIG. 2 is a flowchart of a server system according to the preferred embodiment of the present invention in use;

FIG. 3 is another flowchart of a server system according to the preferred embodiment of the present invention in use; and

FIG. 4 is a flowchart of a method of automatically adjusting storage resources for the server system according to the preferred embodiment of the present invention.

### DETAILED DESCRIPTION OF THE PREFERRED EMBODIMENTS

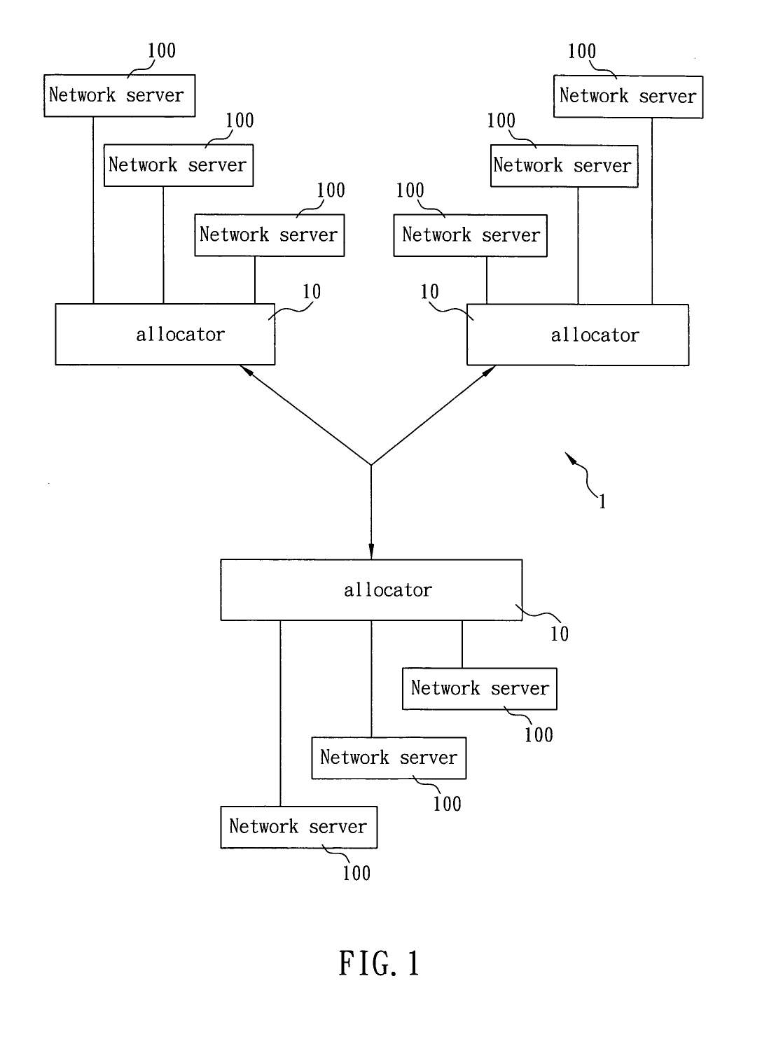

The present invention is related to a method of automatically adjusting storage resources for a server system. Referring now to FIG. 1, a server system according to the preferred embodiment of the present invention is illustrated. As shown, the server system designated by numeral 1 comprises a plurality of allocators 10, each of which corresponds to a plurality of network servers 100.

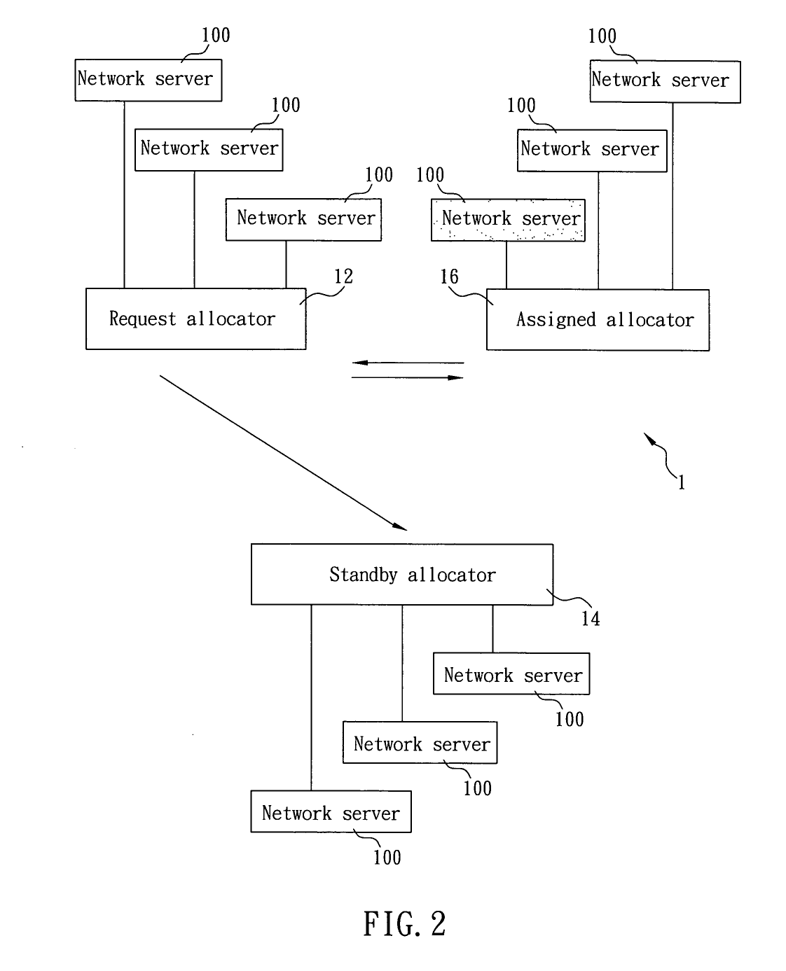

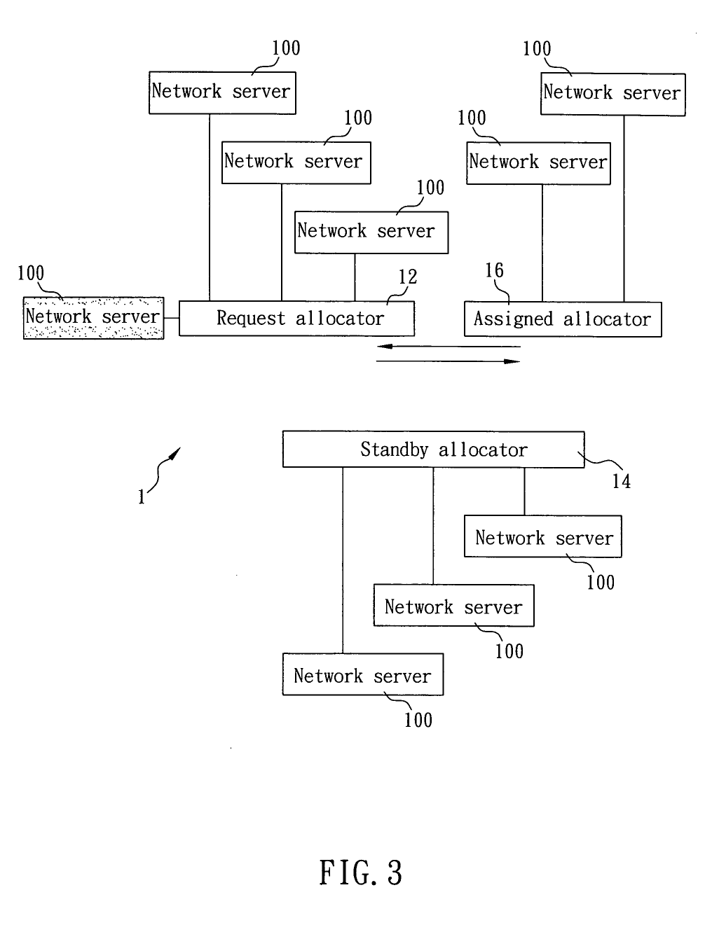

Referring now to FIG. 2, if one of the network servers 100 corresponding to one of the allocators 10 is overloaded, the corresponding allocator 10 will become a request allocator 12 and the other allocators will become standby allocators 14, wherein the request allocator 12 will send an inquiry signal to all of the standby allocators 14 to inquiry if any one of the network servers 100 of the standby allocators 14 is standby or idle for being re-allocated. Referring now to FIG. 3, if the request allocator 12 receives an acknowledgement signal from one of the standby allocators 14, the corresponding standby allocator 14 will be assigned as an assigned allocator 16 while a data request signal of the network server 100 will be sent to the assigned allocator 16 from the request allocator 12. If the request allocator 12 receives a server data from the assigned allocator 16, the request allocator 12 will set the network server 100 corresponding to the server data as an additional network server 100 corresponding to the request allocator 12. Therefore, the server system 1 will dynamically adjust each of the allocators 10 according to the data flow variation of the network so as to prevent overloaded or paralyzed network servers 100 of some of the allocators 10.

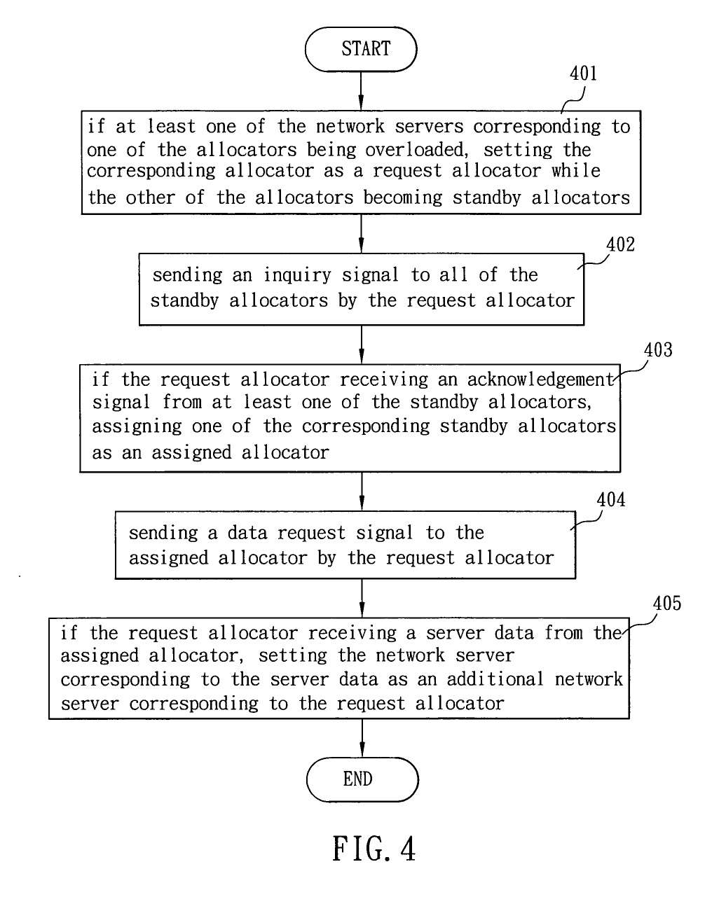

Referring now to FIG. 4, a method of automatically adjusting storage resources for a server system is illustrated, which is described more detailed as the following steps:

In step 401, if at least one of the network servers 100 corresponding to one of the allocators 10 is overloaded, the corresponding allocator 10 becomes a request allocator 12 while the other of the allocators 10 become standby allocators 14;

In step 402, the request allocator 12 sends an inquiry signal to all of the standby allocators 14;

In step 403, if the request allocator 12 receives an acknowledgement signal from at least one of the standby allocators 14, one of the corresponding standby allocators 14 will be assigned as an assigned allocator 16;

In step 404, the request allocator 12 sends a data request signal to the assigned allocator 16;

In step 405, if the request allocator 12 receives a server data from the assigned allocator 16, the request allocator 12 sets the network server 100 corresponding to the server data as an additional network server 100 corresponding to the request allocator 12.

Referring back to FIGS. 1 and 2, in the preferred embodiment of the present invention, before determining if at least one of the network servers 100 corresponds to each of the allocators 10 is overloaded, a real-time overload efficiency information of each of the network servers 100 corresponding to each of the allocators 10 must be calculated followed by determining if the overload efficiency information of the network servers 100 is higher than a predetermined threshold limit value of overload efficiency, so as to decide if at least one of the network servers 100 is overloaded or paralyzed. If the overload efficiency information of all of the network servers 100 corresponds to one of the allocators 10 is higher than the predetermined threshold limit value of overload efficiency, the network servers 100 are determined to be in an overloaded state and the corresponding allocator 10 becomes the request allocator 12 while the other allocators 10 become standby allocators 14.

Referring still to FIG. 1, in the preferred embodiment of the present invention, when calculating the overload efficiency information of allocator 10, the allocator 10 respectively sends an overload detection packet to each of the network servers 100 for detecting the real-time overload degree of each of the network servers 100. If the allocator 10 receives an overload response packet sent back by each of the network servers 100, the overload efficiency information of each of the network servers 100 can be calculated according to a transmission time of the overload detection packet sent by the allocator 10 and a receiving time of the overload response packet received by the allocator 10, so that the overload efficiency information of each of the network servers 100 can be used to determine if any of the network servers 100 is in an overloaded or paralyzed state.

Referring to FIGS. 2 and 3 again, in the preferred embodiment of the present invention, after each of the standby allocators 14 receives the inquiry signal prior to sending the acknowledgement signal, a first overload efficiency information of each of the network servers 100 corresponding to the standby allocators 14 must be calculated. If the first overload efficiency information of all of the network servers 100 corresponding to one of the standby allocators 14 are lower than the predetermined threshold limit value of overload efficiency of said standby allocator 14, calculating a second overload efficiency information of the network servers 100 remained after removing one of the network servers 100 from said standby allocator 14. If the second overload efficiency information of the remaining network servers 100 is still lower than the predetermined threshold limit value, said standby allocator 14 will output the acknowledgement signal to the request allocator 12. Thus, if any one of the network servers 100 of said standby allocator 14 is standby or idle, the acknowledgement signal will be outputted to the request allocator 12, so that the request allocator 12 can adjust the load of the network servers 100 corresponding to request allocator 12 according to the acknowledgement signal.

Referring back to FIGS. 2 and 3, in the preferred embodiment of the present invention, before said standby allocator 14 outputs the acknowledgement signal to the request allocator 12, the second overload efficiency information of each of the remaining network servers 100 is pre-stored in the acknowledgement signal, so that the request allocator 12 can determine which one of the standby allocators 14 has the highest second overload efficiency information according to the acknowledgement signal. Then, the acknowledgement signal will be transmitted to the request allocator 12 by said standby allocator 14, while removing one of the network servers 100 of the assigned allocator 16 in a real-time hot plugging manner. If the assigned allocator 16 receives the data request signal, the server data of the removed network servers 100 will be transmitted to the request allocator 12 for being set by the request allocator 12.

Referring still to FIG. 3, in the preferred embodiment of the present invention, when the request allocator 12 assigns the assigned allocator 16 according to the method of the present invention, the request allocator 12 respectively accesses the second overload efficiency information stored in the acknowledgement signal so as to determine which one of the standby allocators 14 has the lowest second overload efficiency information followed by assigning said standby allocator 14 with the lowest second overload efficiency information as the assigned allocator 16, to which the data request signal is transmitted. The server data can be preferably selected from a connection configuration file. Meanwhile, if suitably selecting at least one of the network servers 100 of the assigned allocator 16, the storage resources of the server system 1 can be averagely adjusted.

Furthermore, in the preferred embodiment of the present invention, after the request allocator 12 sets at least one of the network servers 100 corresponding to the server data as at least one additional network server 100 of the request allocator 12, the request allocator 12 sends a confirmation signal to the assigned allocator 16 so as to finish adjusting the load of the request allocator 12.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method of automatically adjusting storage resources for a server system, which is applied to the server system provided with a plurality of allocators each corresponding to a plurality of network servers, comprising:
when one of the network servers corresponding to one of the allocators is overloaded, setting the corresponding allocator as a request allocator while the other allocators becoming standby allocators, and then sending an inquiry signal to all of the standby allocators by the request allocator;
when the request allocator receives an acknowledgement signal sent from at least one of the standby allocators, assigning one of the standby allocators sending the acknowledgement signal as an assigned allocator, and then sending a data request signal of adjusting the network servers to the assigned allocator by the request allocator; and
when the request allocator receives a server data from the assigned allocator, setting the network server corresponding to the server data as an additional network server corresponding to the request allocator.

2. The method of automatically adjusting storage resources for the server system of claim 1 wherein, when determining whether one of the network servers corresponding to one of the allocators is overloaded or not, further comprising:
calculating an overload efficiency information of the network server; and
when the overload efficiency information of the network server is higher than a predetermined threshold limit value of overload efficiency of the corresponding allocator, determining that the network server corresponding to the allocator is overloaded.

3. The method of automatically adjusting storage resources for the server system of claim 2 wherein, when calculating the overload efficiency information, further comprising:
sending an overload detection packet to each of the network servers by the allocator respectively, for detecting a real-time overload degree of each of the network servers;
receiving an overload response packet sent respectively from each of the network servers by the allocator; and
calculating the overload efficiency information of each of the network servers according to a transmission time of the overload detection packet sent by the allocator and a receiving time of the overload response packet received by the allocator.

4. The method of automatically adjusting storage resources for the server system of claim 1 wherein, after each of the standby allocators receives the inquiry signal prior to sending the acknowledgement signal, further comprising:
calculating a first overload efficiency information of each of the network servers corresponding to the standby allocators;
when the first overload efficiency information of all of the network servers is lower than a predetermined threshold limit value of overload efficiency of the corresponding standby allocator, calculating a second overload efficiency information of the network servers remained after removing one of the network servers corresponding to the standby allocator; and
when the second overload efficiency information of the remaining network servers is lower than the predetermined threshold limit value of the corresponding standby allocator, outputting the acknowledgement signal to the request allocator by the standby allocator.

5. The method of automatically adjusting storage resources for the server system of claim 4 wherein, before the standby allocator outputs the acknowledgement signal to the request allocator, the second overload efficiency information of each of the remaining network servers is pre-stored in the acknowledgement signal.

6. The method of automatically adjusting storage resources for the server system of claim 4 wherein, after the standby allocator transmits the acknowledgement signal prior to receiving the data request signal by the assigned allocator, one of the network servers corresponding to the assigned allocator is removed in a real-time hot plugging manner.

7. The method of automatically adjusting storage resources for the server system of claim 6, wherein if the assigned allocator receives the data request signal, the server data of the removed network servers is transmitted to the request allocator.

8. The method of automatically adjusting storage resources for the server system of claim 5 wherein, when the request allocator assigns the assigned allocator, further comprising:
accessing the second overload efficiency information stored in the acknowledgement signal; and
when determining one of the standby allocators has the lowest second overload efficiency information, assigning the standby allocator with the lowest second overload efficiency information as the assigned allocator.

9. The method of automatically adjusting storage resources for the server system of claim 8 wherein, after the request allocator sets at least one of the network servers corresponding to the server data as at least one additional network server of the request allocator, the request allocator sends a confirmation signal to the assigned allocator.

10. The method of automatically adjusting storage resources for the server system of claim 6 wherein, when the request allocator assigns the assigned allocator, further comprising:
accessing the second overload efficiency information stored in the acknowledgement signal; and
when determining one of the standby allocators has the lowest second overload efficiency information, assigning the standby allocator with the lowest second overload efficiency information as the assigned allocator.

11. The method of automatically adjusting storage resources for the server system of claim 10 wherein, after the request allocator sets at least one of the network servers corresponding to the server data as at least one additional network server of the request allocator, the request allocator sends a confirmation signal to the assigned allocator.

12. The method of automatically adjusting storage resources for the server system of claim 7, wherein when the request allocator assigns the assigned allocator, further comprising:
accessing the second overload efficiency information stored in the acknowledgement signal; and
when determining one of the standby allocators has the lowest second overload efficiency information, assigning the standby allocator with the lowest second overload efficiency information as the assigned allocator.

13. The method of automatically adjusting storage resources for the server system of claim 12 wherein, after the request allocator sets at least one of the network servers corresponding to the server data as at least one additional network server of the request allocator, the request allocator sends a confirmation signal to the assigned allocator.
